(19) United States
(12) Patent Application Publication
(10) Pub. No.: US 2017/0270082 A1
(43) Pub. Date: Sep. 21, 2017

(54) DYNAMIC RENDERING OF GEOGRAPHIC DATA

(71) Applicant: MICROSOFT TECHNOLOGY LICENSING, LLC, Redmond, WA (US)

(72) Inventors: James Thomas Marshall, Redmond, WA (US); Ehab Sobhy Deraz, Redmond, WA (US); Jimmy Y. Sun, Redmond, WA (US); Matthew W. Asplund, Kirkland, WA (US); Jai Srinivasan, Bellevue, WA (US); David Ping Tang, Redmond, WA (US)

(21) Appl. No.: 15/145,742

(22) Filed: May 3, 2016

Related U.S. Application Data
(60) Provisional application No. 62/311,298, filed on Mar. 21, 2016.

(51) Int. Cl. G06F 17/22; G06T 11/00; G06T 1/20; G06T 11/20; G06F 3/0482; G06F 3/0484

(52) U.S. Cl. CPC G06F 17/2241; G06F 3/0482; G06F 3/04842; G06T 1/20; G06T 11/206; G06T 11/001; G06T 2210/36

(57) ABSTRACT

Computer systems, methods, and computer storage media for dynamically rendering geographic data. Geographic data is dynamically rendered as a digital map such that changes to the corresponding geographic data are automatically applied to the map and the map is automatically updated to show the changes to the geographic data. The map is rendered to give the most effective view of the corresponding geographic data by determining a least common ancestor of identified geographic entities. The least common ancestor is the lowest ranked geographic entity, within a geographic hierarchy, that is still common to all of the identified geographic entities within a set of geographic data.

### CROSS-REFERENCE TO RELATED APPLICATIONS

This non-provisional application claims the benefit of and priority to U.S. Provisional Patent Application Ser. No. 62/311,298, filed on Mar. 21, 2016, and entitled “DYNAMIC RENDERING OF GEOGRAPHIC DATA,” and which is expressly incorporated herein by this reference in its entirety.

### BACKGROUND

Some computer applications are configured to present geographic data in the form of digital map visualizations. Typically, a map visualization will include various map elements such as roads, landmarks, and sometimes geopolitical or natural borders. Often, such map visualizations are presented as images that can be inspected through a combination of zooming and panning actions. In many instances, to form a map that visualizes a given set of data, a suitable background map image is obtained and the corresponding data is manually superimposed on the image.

Maps may be projected in various ways. Because most maps are 2-dimensional representations of what is in reality a 3-dimensional surface, various map projection techniques have been developed to transform locations on the surface of a sphere or ellipsoid into locations on a planar surface. All map projections distort the displayed surface to some extent in order to highlight or better show certain aspects of the map. Thus, some projections may be better suited to some types/uses of maps while other projections may be better suited to other types/uses of maps.

### BRIEF SUMMARY

The present disclosure relates to computer systems, methods, and computer storage media for dynamically rendering geographic data. In some embodiments, geographic map data is used to dynamically generate and render a digital map. In some instances, changes to the corresponding/underlying geographic data are automatically applied to the map and the map is automatically updated to show the changes to the geographic data.

As described herein, various methods, systems, and storage devices are provided for receiving a data set having one or more geographic entities, such as countries, states/provinces, counties, cities, etc., and parsing the data to identify the one or more geographic entities of the data set. A map is then rendered to visualize the one or more geographic entities according to a least common ancestor of the identified geographic entities. The least common ancestor represents the lowest ranked geographic entity, within a hierarchy of geographic entities, which is common to all of the identified geographic entities.

According to some embodiments, a data set includes one or more data values corresponding to respective geographic entities, and a computing system receiving the data set is configured to generate a map rendering the geographic entities according to the data values associated with the geographic entities in order to provide a generated visual display of the data values associated with the geographic entities, such as a color-coded map, heat map, density map, map with appended data labels, and the like.

In some embodiments, a computer system is configured to dynamically update a rendered map in response to updates and/or modifications to a data set underlying the rendered map in order to better display the underlying geographic data. In some embodiments, for example, a rendered map dynamically updates to present a modified view in response to an update or a modification to a data set that changes the identity of the least common ancestor.

Additional features and advantages will be set forth in the description, which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present disclosure, a more particular description of the disclosure will be rendered by reference to specific embodiments thereof which are illustrated in the appended drawings. It is appreciated that these drawings depict only illustrated embodiments of the disclosure and are therefore not to be considered limiting of its scope. Embodiments of the disclosure will be described and explained with additional specificity and detail through the use of the accompanying drawings in which:

FIG. 1 illustrates a computing environment that can be used to dynamically render geographical data;

FIGS. 2A-2B illustrate examples of discontiguous regions and corresponding bounding boxes for determining processing needs of the discontiguous regions;

FIGS. 3A-3C illustrate exemplary map views according to different geographic hierarchy levels;

FIG. 4 illustrates an exemplary map chart area for handling discontiguous regions;

FIGS. 5A-5B illustrates different map views according to an excess removed selection;

FIG. 6 illustrates an exemplary map view having appended geo-data labels identifying geographic regions and data values associated with the geographic regions;

FIGS. 7A-7B illustrate exemplary maps according to various color schemes and/or geographic data presentations;

FIGS. 8A-8B illustrate map views showing point-type geographic data in different exemplary bubble map representations;

FIG. 9 illustrates a user interface showing a rendered map and a status message; and

FIGS. 10-12 are flowcharts of various exemplary methods for dynamically rendering geographic data.

### DETAILED DESCRIPTION

The present disclosure relates to computer systems, methods, and computer storage media for dynamically rendering geographic data. In some embodiments, digital maps are dynamically generated and geographic data is dynamically rendered within the digital maps such that changes to the corresponding geographic data are automatically applied to the maps and the maps are automatically updated to show the changes to the geographic data.

Various technical effects and benefits may be achieved by implementing the aspects of the disclosed embodiments. By way of example, the disclosed embodiments can enable automatic generation and automatic updating of geographic data in a map visualization format. Technical effects therefore include improved user convenience as well as efficiency gains by reducing the number of steps required to generate and/or update a map representing one or more pieces of geographic data. In at least some circumstances, technical effects include efficiency gains through a reduction in processing overhead required to generate and render a map representing a number of geographic entities, and particularly through a reduction in the number of separate processing operations required for receiving and processing multiple user inputs for reversing, correcting, and otherwise adjusting a map to achieve a view that sufficiently represents the corresponding geographic data in an efficient manner.

In this description and in the claims, the term “computing system” or “computer architecture” is defined broadly as including any device or system (or combination thereof) that includes at least one physical and tangible processor, and a physical and tangible memory capable of having thereon computer-executable instructions that may be executed by the processor.

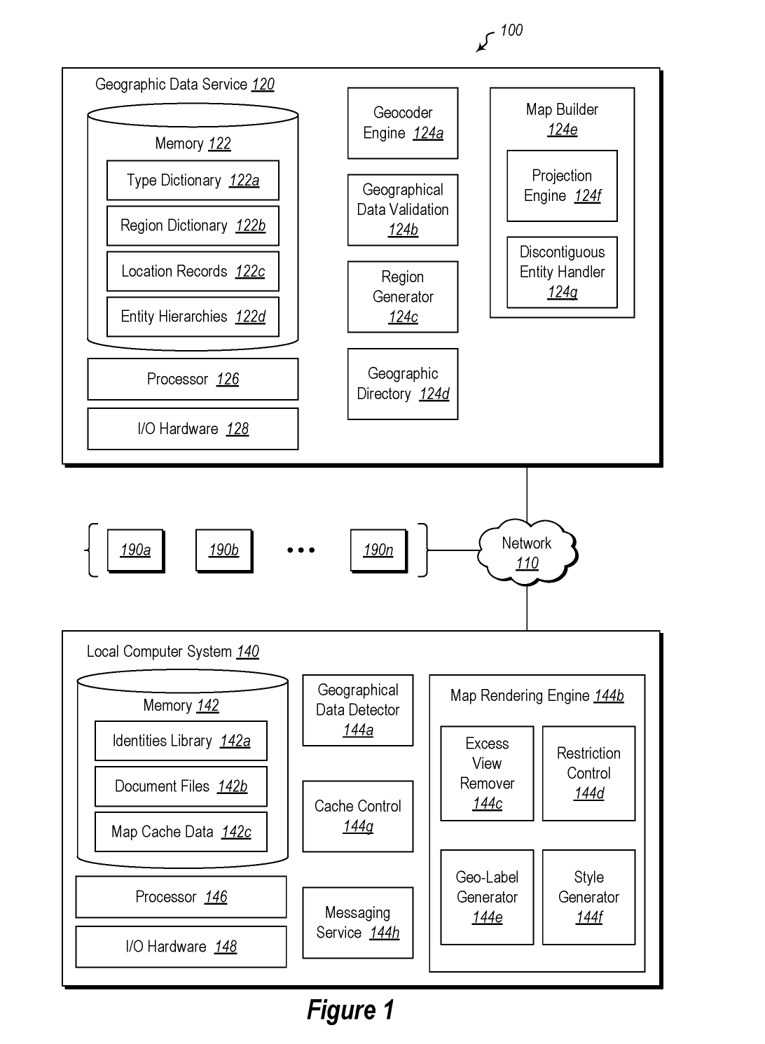

FIG. 1 illustrates an exemplary computer architecture 100 in which geographic data is dynamically rendered. The illustrated embodiment includes a geographic data service 120 in communication with a local computer system 140. Although a single local computer system 140 is shown in FIG. 1, it will be understood that any number of rendering applications on any number of client computer devices may be included in the architecture 100.

The geographic data service 120 and the local computer system 140 are connected by (or are part of) a network 110, such as, for example, a Local Area Network (“LAN”), a Wide Area Network (“WAN”), and even the Internet.

The illustrated geographic data service 120 includes memory 122, and the illustrated local computer system 140 includes memory 142. Each of the geographic data service 120 and the local computer system 140 also include at least one processing unit 126 and 146, respectively. The memory 122 and the memory 140 may independently be physical system memory, which may be volatile, non-volatile, or some combination of the two. The term “memory” may also be used herein to refer to non-volatile mass storage such as physical storage media.

The illustrated geographic data service 120 and local system 140 each include input/output (I/O) hardware 128 and 148, respectively. The I/O hardware may include one or more keyboards, mouse controls, touch screens, microphones, speakers, display screens, track balls, and the like to enable the receiving of information from a user and for displaying or otherwise communicating information to a user.

The geographic data service 120 also includes a number of executable modules or executable components 124a-124g, and the local system 140 includes a number of executable modules or executable components 144a-144h. As used herein, the term “executable module” or “executable component” can refer to software objects, routings, or methods that may be executed on the computing system. The different components, modules, engines, and services described herein may be implemented as objects or processes that execute on the computing system (e.g., as separate threads).

The various components illustrated in FIG. 1 represent only a few example implementations of a geographic data rendering system. For example, other embodiments may divide the described components and functions differently among the geographic data service 120 and the local computer system 140, and some embodiments may move more of the processing toward the local computer system than the service, or vice versa, relative to the particular embodiment illustrated in FIG. 1.

In some embodiments, the local system 140 and the geographic data service 120 are integrated into a single or plurality of standalone or enterprise computing systems. In other embodiments, program modules are distributed across a plurality of constituent computer systems in a distributed environment, such as, in addition to or alternative to the illustrated data service 120 and local system 140, across a plurality of computer system components 190 (e.g., any number 190a to 190n, as indicated by the ellipses). In such embodiments, the processing, memory and/or storage capability of the architecture 100 may be distributed as well. Accordingly, the systems and methods described herein are not intended to be limited based on the particular location at which components are located and/or at which functions are performed.

According to the illustrated embodiment, the memory 122 is used for storing an entity type dictionary 122a, which lists the particular entity type for various geographic entities, such as continent, country, state (or province or other sub-country geographic unit one level below country), county, zip code, etc. For example, type dictionary 122a lists terms such as “United States” as a country, “California” as a state, and so on. The illustrated memory 122 also includes a region dictionary 122b, which includes size and shape data of various geographic regions (e.g, polygons illustrating the shapes of various geographic entities). The illustrated memory 122 also includes location records 122c, which includes location data for various geographic entities (e.g., latitude and longitude data, relative locations to other geographic entities, area codes).

The illustrated memory 122 also includes entity hierarchies 122d, which maps the hierarchical relationships between various geographic entities. For example, the United States is a parent to California, Oregon is a sibling to California, the world is a parent to the United States and a grandparent to California and Oregon, etc. The hierarchical relationships data 122d can include hierarchies extending further to even more lower levels. For example, counties, zip codes, and the like. In addition, cities, business locations, and other geographic entities that are typically or more effectively rendered on a map as a “point” entity may also be included. Further, not all hierarchies are limited to geopolitical boundaries, and one or more hierarchies may relate other geographic entities that do not necessarily align with or correspond to geopolitical boundaries (e.g., watershed regions, national parks, wilderness reserves, climate zones, etc.).

The geographic data service 120 includes a geocoder engine 124a configured to determine the geographic position of a given geographic entity. For example, the geocoder engine 124a can receive a list of one or more geographic entities and match or correlate those geographic entities to their respective positions using the location dictionary 122b.

The geographic data service 120 also includes a geographic data validation module 124b configured to validate that received geographic entity data relates to geographic entities. For example, the validation module 124b can validate that a given geographic entity received at the geographic data service 120 is indeed a geographic entity.

The geographic data service 120 also includes a region generator 124c configured to generate a region corresponding to a given geographic entity. For example, the region generator 124c can match the appropriate region polygon from the region dictionary 122b to the given geographic entity in order to provide the shape of the geographic entity for subsequent mapping of the geographic entity. In some embodiments, the region generator 124c is also configured to correlate and position point-type data (e.g., cities) to respective locations upon a higher-level region polygon (e.g., county, state, etc.).

The geographic data service 120 also includes a geographic directory 124d configured to determine the geographic hierarchy of a given geographic entity (e.g., parents, siblings, children), enabling the creation of full maps from partial data (e.g., a full map of the United States given a subset of states present in a geographic data set). For example, the geographic directory 124d can match a given geographic entity to an appropriate hierarchy of the entity hierarchies 122d.

The geographic data service 120 also includes a map builder 124e configured to generate the most functional, informative, and/or appropriate map view based on a given data set of geographic entities. The map builder 124e is configured to visualize the geographic entities of the given data set at the most granular level available while still being able to fully visualize all of the geographic entities of the data set.

In some embodiments, the map builder 124e determines a least common ancestor representing the lowest level geographic entity that is a common parent of all geographic entities included in a set of geographic entities. For example, for a data set consisting of a set of states or provinces that are all part of one country, the least common ancestor would be the country, for a data set consisting of counties or zip codes that are all part of one state/province, the least common ancestor would be the state/province, for a data set consisting of a set of African countries, the least common ancestor would be the world (or alternatively, the African continent in embodiments in which continents are included as a valid hierarchal level).

In some embodiments, the least common ancestor for a set geographic entities is determined by: (1) for each geographic entity in the set, traversing up its geographic hierarchy to identify its parent, grandparent, etc., (2) determining the lowest hierarchical level at which all geographic entities traverse to a common single geographic entity, and (3) identifying the common single geographic entity as the least common ancestor.

The illustrated map builder 124e also includes a projection engine 124f configured to assist the map builder in building a map appropriately according to a preset or selected geographic region projection style. For example, the projection engine 124f can ensure the proper polygonal regions are pulled from the region dictionary 122b so as to match the preset or selected projection style for the generated map. For example, some maps may be preset or user-selected to display the geographic regions of the map according to an equirectangular, Cassini, Mercator, Gauss-Kruger, Miller, Robinson, or Behrmann style projection, or any other type of projection, and the projection engine 124f can ensure that the proper geographic regions that correlate to the given projection style are selected and coordinated to build the map.

In some embodiments, one or more types of projections are associated with the hierarchical level at which the map is to be displayed. For example, a map displayed at the continent or world level may be displayed with a Mercator or Robinson projection, whereas a map displayed at the country level or lower levels may be displayed with an Albers projection. In some embodiments, preferred default projection types for different hierarchal map levels are user-selectable.

The illustrated map builder 124e also includes a discontiguous entity handler 124g configured to manage geographic entities having one or more discontiguous regions (e.g., states not connected to the mainland, distant territories). In some embodiments, territories and other unincorporated regions of a country are not associated with the country during the map building. For example, the map builder 124e can be configured to not differentiate between a territory and a country, such that a given territory is treated as its own country as opposed to being tied to the country as a child of the country. For example, in building a map of the United States (e.g., based on a data set of different states), territories such as Puerto Rico and Guam are not shown in the country map view. Alternatively (e.g., according to user-preference and/or user-selected controls), territories may be included as children of the country and mapped accordingly.

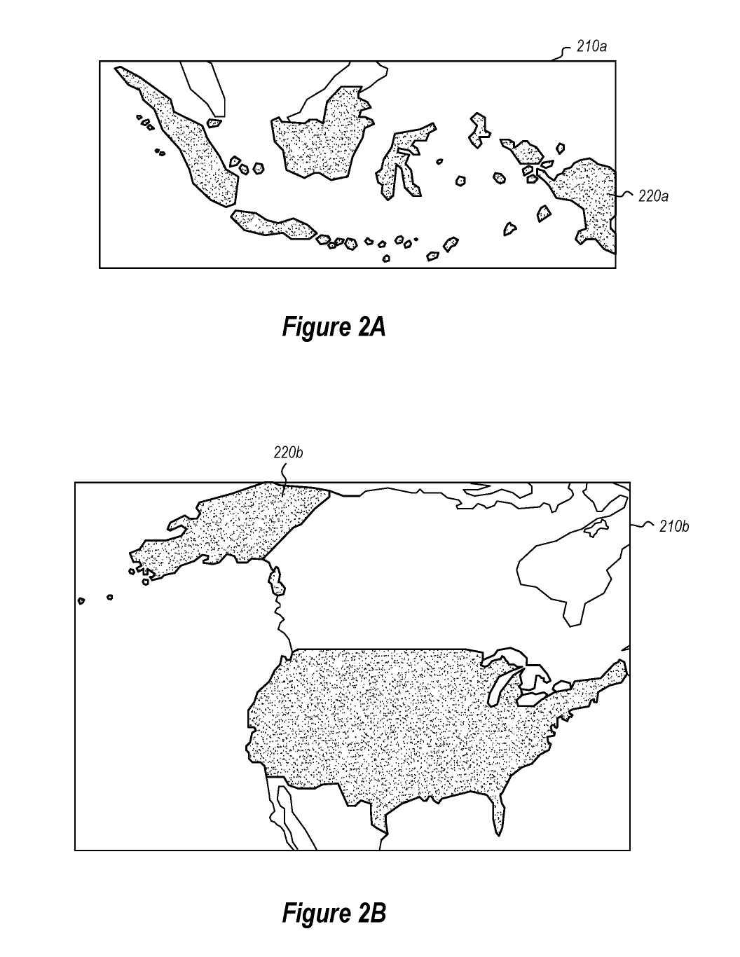

The discontiguous entity handler 124g is also configured to reconfigure certain discontiguous regions for more effective display. For example, as shown in FIG. 2A, where a good bounding box 210a can be drawn over the entire area to be mapped 220a (as with the illustrated Indonesia example), there is no need for special handling of the geographic entity to be mapped. Alternatively, as shown in FIG. 2B, where a bounding box 210b taking in all of the discontiguous regions of the area to be mapped 220b is too large to the point of losing desired fidelity and detail of the map (as with the illustrated Alaska and mainland United States example), special processing is employed to render the discontiguous regions in a manner that maintains map fidelity, as explained in more detail below. A preset or user-selected list of countries or other regions requiring special discontiguous processing may be included in storage 122, and the list may be updated to keep current with changing geopolitical borders and the like.

The illustrated local computer system 140 includes memory 142. Memory 142 includes geographic identities library 142a, which includes records and/or data related to identifying certain terms as representing geographic entities. The memory 142 also includes document files 142b and map cache data 142c for storing information about generated maps, generated map information embedded within other file types (e.g., documents, spreadsheets, etc.), cached information received from the geographic data service 120, and the like.

The illustrated local system 140 includes a geographic data detector 144a configured to parse a set of data to identify geographic entities within the data. In one example, a data set is presented in the form of a table, where one of the dimensions (e.g., one of the columns in the table) is related to a list of geographic entities and another dimension (e.g., another column) relates to non-geographic data corresponding to the listed geographic entities. Examples of such tabulated data sets are shown in Tables 1 and 2 below. The table data can be stored within the memory 142 of the local computer system 140, memory 122 of the geographic data service, and/or any third party system 190a-n.

The geographic data detector 144a is configured to parse the data set to determine the list of geographic entities by, for example, comparing data of the data set to the identities library 142a. The geographic data detector 144a is also configured to send the identified geographic entities to the geographic data service 120 so that the service may build mapping data related to the geographic entities. The geographic data detector 144a includes filtering rules to prevent private and/or sensitive information from being passed through the network 110 to the geographic data service 120. The geographic data detector 144a may also be configured to identify the hierarchy level (i.e., entity type) of each identified geographic entity.

The illustrated local system 140 also includes a map rendering engine 144b configured to render a map of the identified geographic entities and to automatically configure the map for optimum viewing based on an identified least common ancestor of the identified geographic entities. Example map views include world, country, state (or province or similar level entity), county, zip code, etc. The local computer system 140 can be configured such that, by default, the determined optimum map view is shown when the map is generated/rendered.

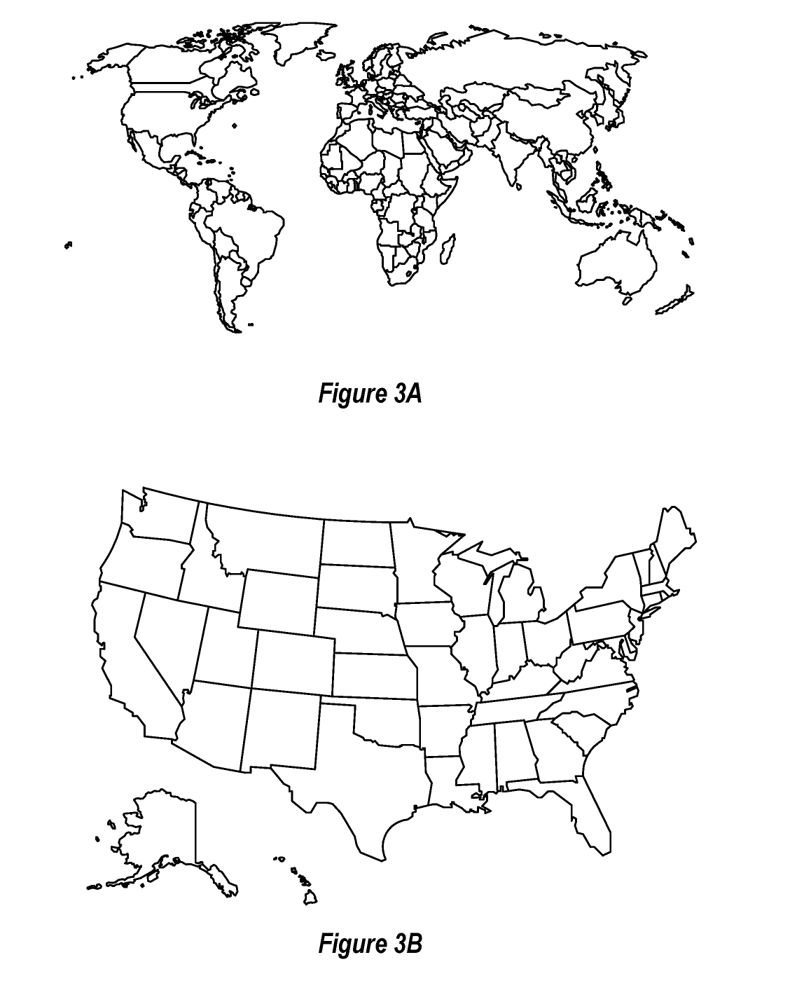

An exemplary world map view is illustrated in FIG. 3A. The world map view is typically used when the data set includes multiple countries and/or includes regions in multiple countries. This view is capable of supporting multiple lower level region entity types (e.g., country, state, county, zip code, cities and other data points).

An exemplary country map view is shown in FIG. 3B. The country map view is used when the data set's regions are all captured within one single country. This view is capable of supporting multiple lower level region entity types (e.g., state, county, zip code, cities and other data points.

An exemplary state map view is illustrated in FIG. 3C. The state map view is used when the data set's regions are all captured within a single state (or other corresponding geographic entity such as a province). Each view (e.g., world, country, state, will provide a viewport that best contains all of the regions in the data set, along with a reasonable amount of spacing between the displayed regions and the edge of the map display.

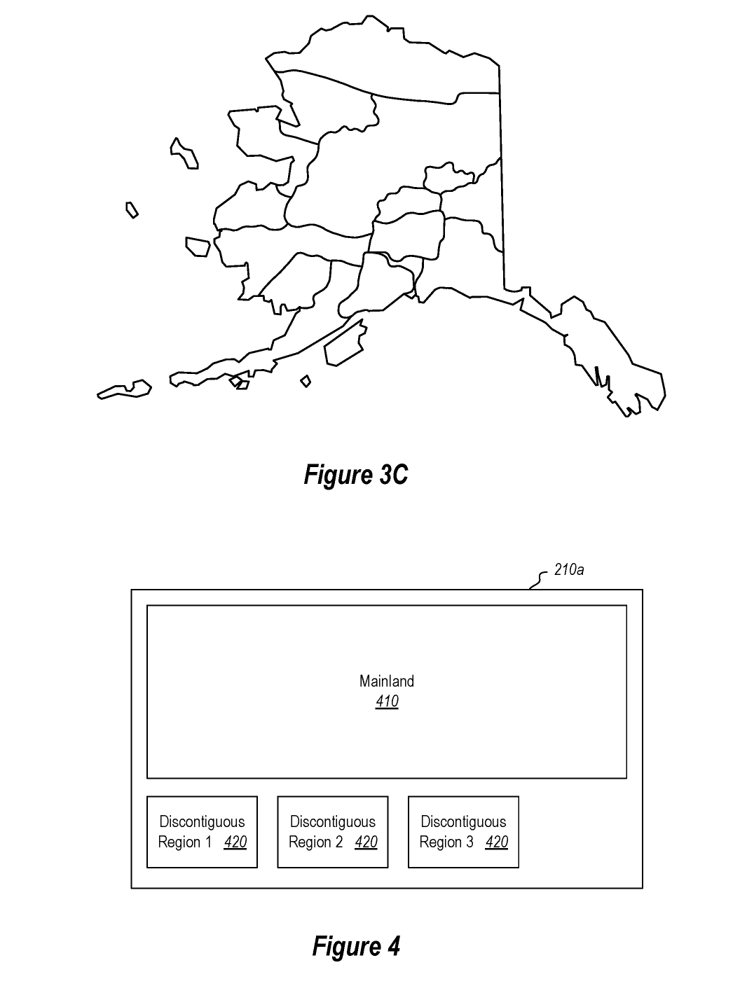

Certain geographic regions will require special processing to appropriately display discontiguous regions. The United States is one such example, where Hawaii and Alaska are so far removed from the mainland that a good view of all regions is difficult to establish. An exemplary layout 400 for countries having one or more discontiguous regions is illustrated in FIG. 4, showing a mainland area 410, and discontiguous region areas 420. The same functionality is not limited to discontiguous countries. In some embodiments, the same functionality is applied to states or regions of other hierarchical level having discontiguous regions to be rendered.

The map rendering engine 144b includes an excess view remover 144c configured to adjust a map view in order to increase the map focus and/or zoom level on the areas corresponding to the identified geographic data. In some embodiments, for example, an entire world, continent, country, or state may be shown by default. However, if the data only pertains to a small portion of the map view (e.g. a few clustered counties within a state), then there exists a significant amount of excess regions that do not contain data. This excess can be removed to provide higher-fidelity viewing of the regions that do contain data.

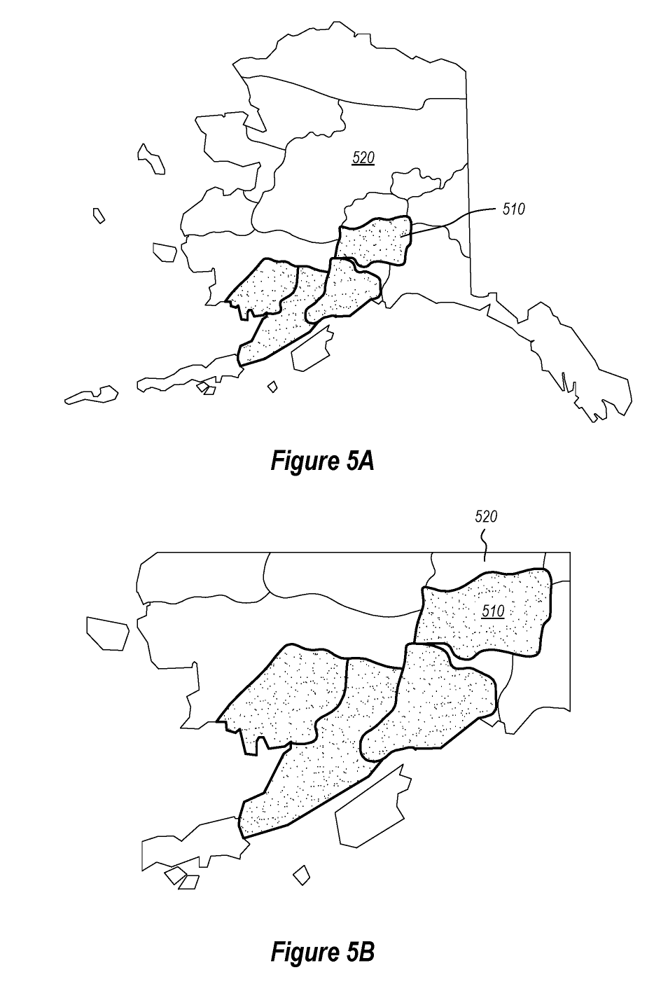

FIGS. 5A and 5B illustrate the difference between a whole region view (FIG. 5A) and an excess-removed view (FIG. 5B) of an exemplary state map view. As shown, only a relatively small section of the displayed state pertains to the data (data region 510) while the rest of the state does not contain any data (non-data region 520). The computer system enables a user to toggle from the whole region view of FIG. 5A to the excess removed view of FIG. 5B. In some embodiments, the preferred default presentation of such views may be set by a user. The map rendering engine 144b may be configured to provide one or the other type of view by default (e.g., as selected by a user), and/or is configured to enable user-selection between such views after generation/rendering of the map view.

The illustrated map rendering engine 144b also includes a restriction control 144d configured to manage latency in the rendering of the map views, which may be a result of, for example, geocoding and region shape retrieval. In some embodiments, the restriction control 144d restricts the rendering of certain levels of geographic entity types in order to limit the number of individual geographic polygons or other shapes that must be rendered at any particular time. For example, in maps where the identified geographic entities are not the immediate children of the least common ancestor (e.g., least common ancestor is the world and the identified geographic entities are states of different countries, or least common ancestor is a country and the identified geographic entities are counties of different states), then a higher relative number of geographic region shapes would need to be rendered to show the highest level of detail.

In some embodiments, the restriction control 144d is set (by default or according to user-selection) to restrict rendering. For example, the restriction control 144d may be set to restrict rendering according to the following rules: if the mapped region entity type is the immediate child of the least common ancestor, render all regions of the mapped entity type (e.g., both regions that contain data and those that don't); if the mapped region entity type is a further descendant of the least common ancestor, then only render those regions of the mapped entity type that contain data.

According to some embodiments, the restriction control 144d dynamically adjusts the rendering of the generated map in response to changes to the hierarchal level at which the map is displayed. For example, when a map is changed from a higher-level view to a lower-level view (e.g., country view to state view), the map rendering engine may adjust the map to display lower level geographic entities that were not displayed prior to the view adjustment (e.g., individual counties of the state). The change in map views may occur as a result of manual selection/zooming, or as explained in more detail below, may occur automatically as a result of changes to the underlying data set from which the map is generated. In a similar manner, a change from a lower-level view to a higher-level view may result in previously rendered geographic entities no longer being rendered.

In some embodiments, the map rendering engine 144b includes a geo-label generator 144e configured to add/annotate one or more data values to the map such that the data values are associated with the region(s) of the map to which they correspond. In some embodiments, name geo-labels (e.g., country names, state names) are automatically appended to one or more displayed regions of the map. For example, the geographic labels may be provided by the geographic data service 120 and used by the geo-label generator 144e to annotate the corresponding geographic regions of the map.

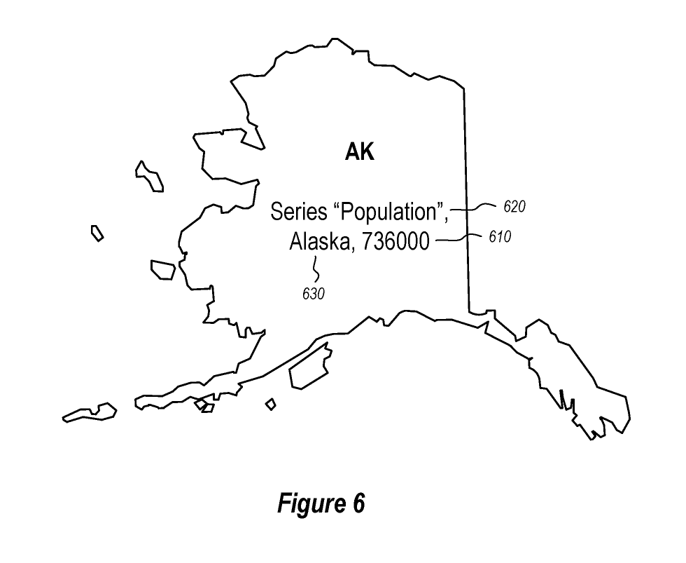

As shown in FIG. 6, data labels may include one or more of value, series name, and category name, for example. The data displayed by the geo-labels may be set according to predefined defaults and/or user preference. For example, FIG. 6 illustrates an Alaska state map configured to show the value label 610 (displaying a value of “73600”) along with the series label 620 (displaying the series “Population”) and a category label 630 (displaying the category “Alaska”). Other display settings can enable the display of more or less than that shown in FIG. 6 (e.g., just the value label).

In some embodiments, the geo-label generator 144e is configured to cull a text string of a geo-label if the text string is otherwise unable to be fit within the corresponding geographic region (e.g., to shorten or abbreviate). The functionality of this aspect of the geo-label generator may be predefined or set according to user preference. Additionally, or alternatively, the geo-label generator 144e may be configured to generate call-out labels with corresponding leader lines when the context makes it more visually appearing to do so (e.g., near relatively crowded areas of the map). In some embodiments, the geo-label generator 144e may additionally or alternatively include “mouse-over” or similar functionality, such that appended geo-labels are not shown, or not shown in full, until selected by a user in some fashion.

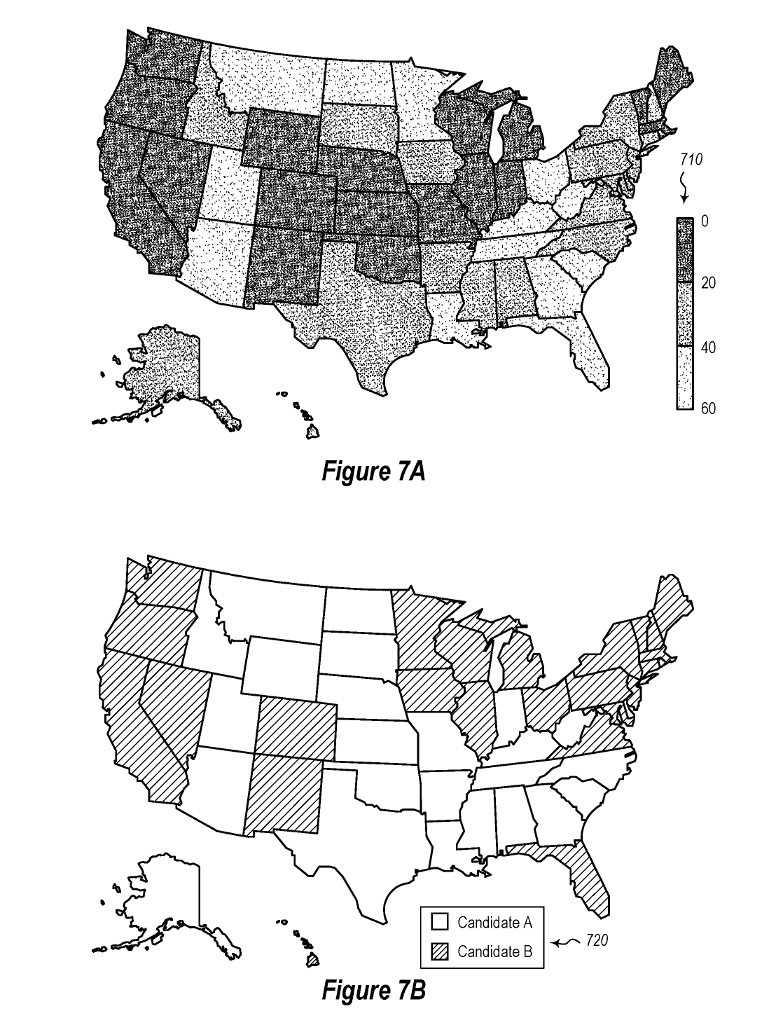

The illustrated map rendering engine 144b also includes a style generator 144f configured to apply a coloring scheme and/or other style properties to the rendered map (e.g., fonts, textures, etc.). In some embodiments, the style scheme is applied according to the set of data values respectively corresponding to the set of geographic entities (e.g., a color-by-value scheme). For example, FIG. 7A illustrates a country map view having a choropleth display, where relative values of the illustrated regions (states in this example) are shown by a gradated style scheme (e.g., gradated range of color(s)), such as a ‘heat/relevance’ type mapping. In some embodiments, each region is rendered according to its corresponding data value as shown by the plotted value dimension 710 displayed alongside the map. In some embodiments, style/color schemes, gradient display, gradient value levels, and other style settings may be configured according to user preferences (e.g., through action of a pop-up wizard).

In some embodiments, the style scheme is applied according to categories in which the geographic entities fall (e.g., a color-by-category scheme). For example, FIG. 7B illustrates a country map view having a category display, where geographic entities (states) belonging to a first category are given a first color, texture and/or styling, and geographic entities belonging to a second category are given a second color, texture and/or other styling. In the illustrated embodiment, a legend 720 is generated to correlate the different colors/styles of the map display to the underlying data.

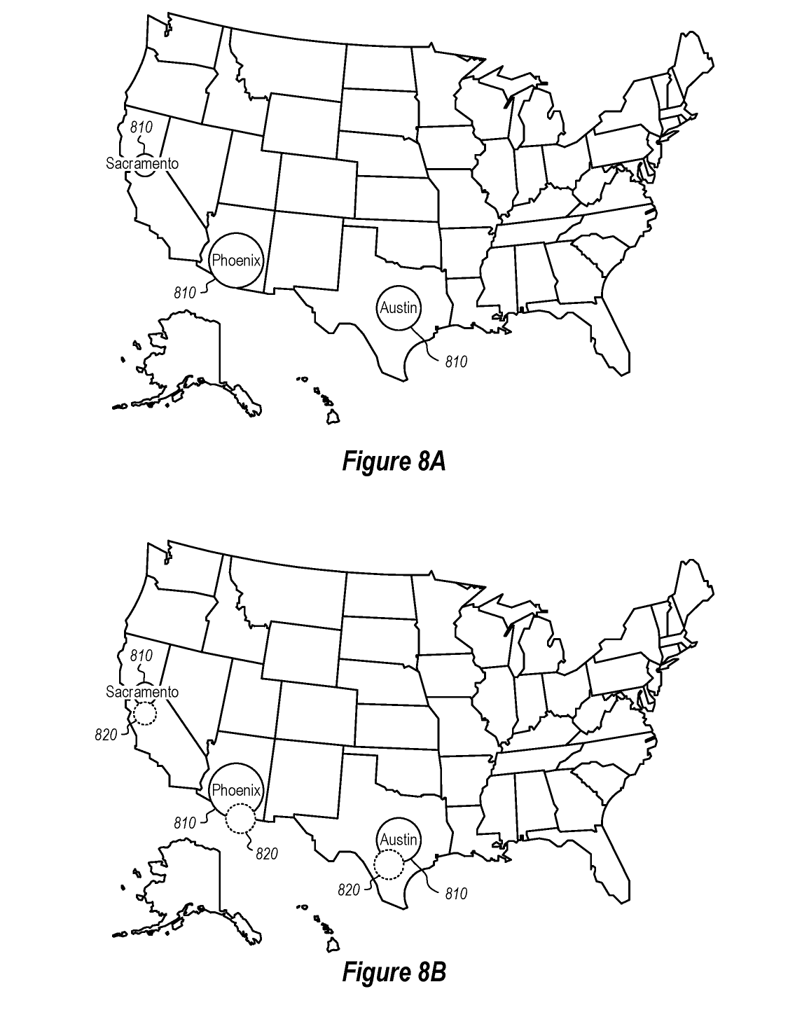

FIG. 8A illustrates another type of map visualization that may be rendered using the embodiments described herein. In the illustrated embodiment, the geographic data is illustrated on the map as a series of “bubbles” 810 having a size that corresponds to underlying data associated with the displayed geographic entities. For example, the illustrated embodiment is a country view map showing various state capital cities, with bubbles 810 associated with the displayed cities that are sized according to relative population of the cites. This type of geographic data representation is particularly useful where one or more data sets correspond to point-type geographic entities, such as cities.

In some embodiments, where the granularity of the received data is set at the level of cities or other point-type geographic entities, the least common region-type ancestor of the set of point-type geographic entities is determined, and the set of point-type geographic entities are automatically displayed within the region of the least common ancestor, with bubbles positioned within the displayed region according to position of the respective point-type geographic entity, and sized according to the respective corresponding data value (e.g., population, average income, etc.). The bubbles are configured, in some embodiments, as selectable objects which (when selected) display additional detail about the underlying data, such as the metric that controls the sizing of the bubbles and/or data that is unrelated to the sizing of the bubbles.

As shown in FIG. 8B, some embodiments include different bubble types simultaneously rendered to represent different data variables and/or different geographic entity types. In the illustrated embodiment, a first bubble type 810 represents a first variable (e.g., total population) and a second bubble type 820 represents a second variable (e.g., population over 50). In this example, the separate variables each relate to the same geographic level. In other embodiments, different bubble types are rendered to represent the same underlying variable, but different geographic hierarchal levels. For example, a first bubble type may represent income levels (or any other variable) at the city level, and a second bubble type may represent income levels at the county level. The bubbles can also correspond to different types of underlying data. The bubbles corresponding to different type and/or hierarchy level are displayed with different coloring/texturing and/or other styling to facilitate easy visual differentiation between the bubble types/levels.

The illustrated local system 140 also includes a cache control 144g configured to manage local caching of data received from the geographic data service 120. In some embodiments, caching of such data (e.g., region shapes, hierarchy structures, geocoding locations) can yield improved performance, particularly in circumstances in which secondary map charts, or similar map charts, are also generated, and/or in circumstances such as refreshing or reopening a file including a map chart.

In some embodiments, the cache is stored in a document file (e.g., spreadsheet file). Alternatively, the cache may be stored in memory 142 of the local device or other device at which the map chart is displayed. In some embodiments, the cache is configured to be purged upon preset or user-defined time limits or other criteria. For example, in order to avoid the use of outdated data (e.g., particularly zip code data or county data or other such data with frequent changes), such cache items may be configured to be purged after a period of time.

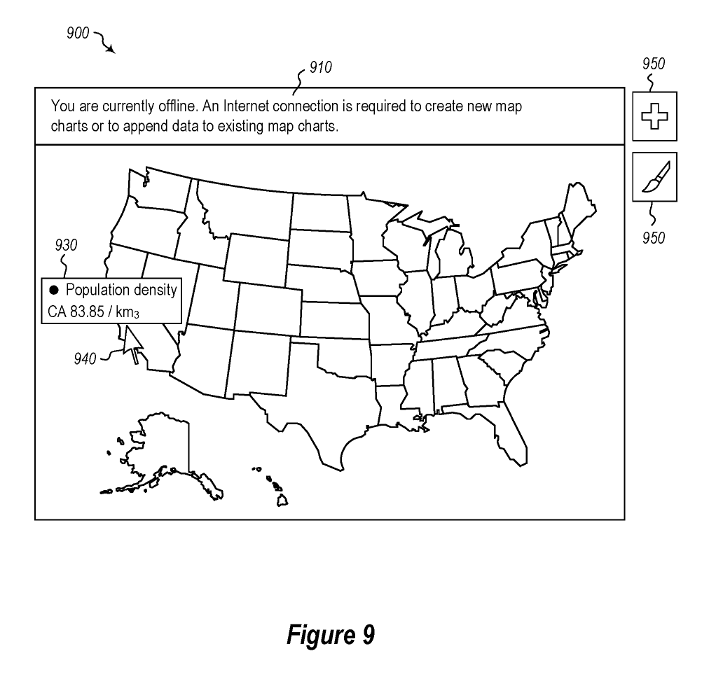

The illustrated local system 140 also includes a messaging service 144h configured to convey information to a user. For example, when the local computer system 140 is offline, when one or more data points could not be geocoded/located, etc. FIG. 9 illustrates an exemplary user interface 900 showing a message 910 informing a user of offline status. Such an “offline status” message 910 may also be generated when a map chart is created while the user was offline, when a user goes offline while viewing a document that includes one or more map charts, and when the user is offline and the cache is purged (due to user's locale not matching the locale saved in the cache), for example.

Other exemplary messaging functions include a geocoding message indicating a failure and/or percentages of data points coded. For example, the messaging service 144h may display a message stating that “We were not able to plot all locations, we plotted <percentage figure> of locations with high confidence.”

FIG. 9 also illustrates an example of a “mouse-over” type data label 930. In some embodiments, data labels are hidden from view until a user selects the corresponding geographic shape. The selection of one or more geographic entities may occur through positioning a mouse pointer 940 over a geographic shape, as shown. Additionally, or alternatively, the selection may occur through touch screen controls, selection of corresponding data in a data table, clicking on one or more geographic shapes, or any other selection technique.

In some embodiments, data labels are appended to respective geographical shapes for constant display. In some embodiments, a portion of the data labels are hidden from view until selected while a portion are constantly shown. For example, maps having a relatively crowded section may hide a number of data labels to reduce clutter at that section while displaying data labels at less crowded sections. Such data label display settings and associated preferred defaults may be user-selected.

FIG. 9 also illustrates various user-selectable objects 950 enabling a user to interact with the map chart to adjust coloring or other styles, layout parameters, defaults, etc. Some embodiments also include links directing a user to the table or other data form underlying the map chart. Such user-selectable objects may be presented in the form of buttons, tabs, menu layouts, and/or other forms of user-selectable objects.

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 122 of the geographic data service 120, the memory 142 of a local computer system, and/or in one or more separate computer system components (e.g., in a distributed computer system environment).

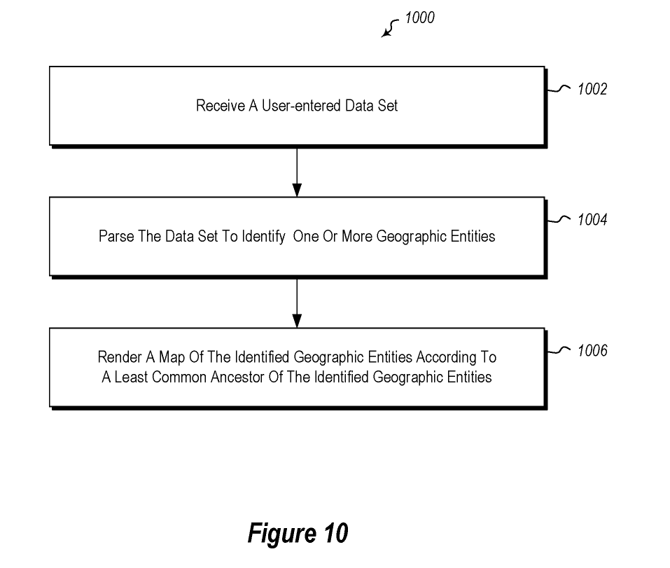

The computer-executable instructions may be used to implement and/or instantiate all of the functionality disclosed herein, including the functionality that is disclosed in reference to the flow diagrams of FIGS. 10-12 and including generation of the various exemplary maps and displays of FIGS. 2-9.

The flowchart 1000 of FIG. 10 illustrates an exemplary method for rendering a map of geographic entities based on a determined least common ancestor of the geographic entities. The method starts with a computing system receiving a user-entered data set (act 1002). In circumstances where the data set includes one or more geographic entities (countries, states, provinces, counties, cities, zip codes, etc.). As shown, the method continues with the computing system parsing the data set to identity the one or more geographic entities (act 1004). Then, based on the identified geographic entities, the computing system renders a map of the identified geographic entities according to a least common ancestor of the identified geographic entities (act 1006). The least common ancestor represents a geographic entity that is common to all of the identified geographic entities and that is located lowest in a geographic hierarchy.

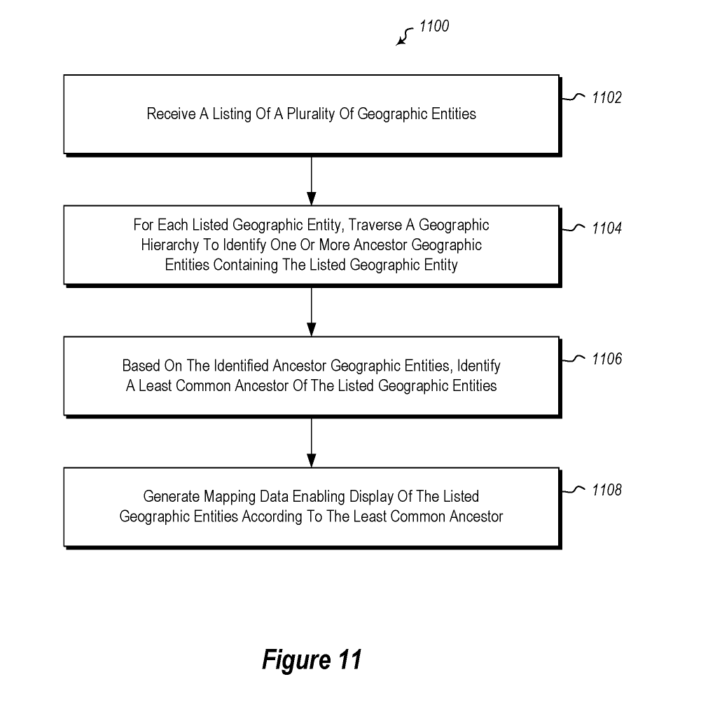

FIG. 11 illustrates a flowchart 1100 of a method for generating mapping data based on a least common ancestor of a listing of geographic entities. The method starts with a computing system receiving a listing of geographic entities (act 1102). The geographic entities of the listing may all be from the same level of a geographic hierarchy (e.g., all entities are U.S. states, or all entities are countries), or may represent different levels of the geographic hierarchy (e.g., U.S. states and U.S. counties). As shown, for each listed geographic entity, the computing system traverses a geographic hierarchy to identify one or more ancestor geographic entities containing the listed geographic entities (act 1104). By way of example, each U.S. state would correspond to the higher-level geographic entities of the U.S. and the world. In embodiments where continents are also included as geographic entities, North America could also be included as a higher-level geographic ancestor.

The computing system then identifies, based on the identified ancestor geographic entities, a least common ancestor of the listed geographic entities (act 1106). As explained above, the least common ancestor is the lowest level ancestor geographic entity that is common to all of the listed geographic entities. As shown, the computing system generates mapping data enabling display of the listed geographic entities according to the least common ancestor (act 1108). Advantageously, the generated mapping data allows a map to be rendered in a manner that most effectively displays all of the corresponding geographic data, while minimizing or eliminating the need for manual zoom and pan adjustments to the generated map.

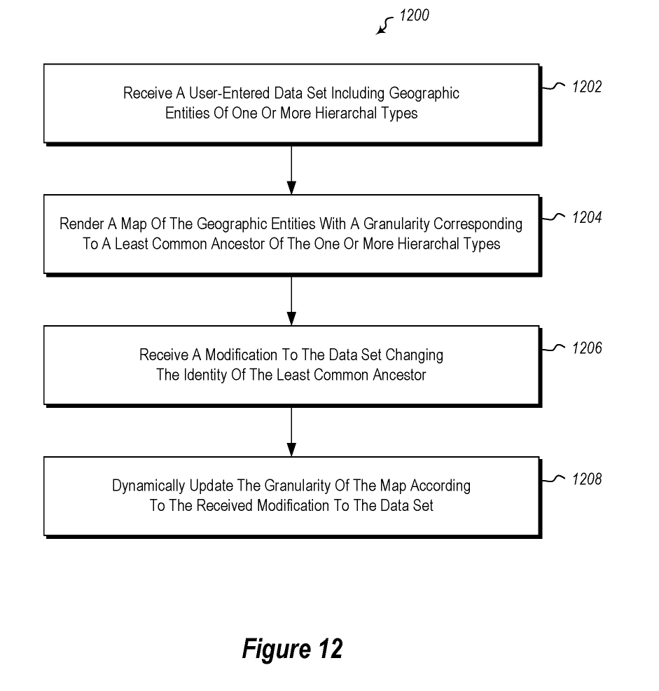

FIG. 12 illustrates a flowchart 1200 showing a method for dynamically updating a map according to an update or modification to a data set underlying the map. As shown, the method begins with a computer system receiving a user-entered data set of geographical entities (act 1202). The geographic entities may be of one or more hierarchal types. The computing system then renders a map of the geographic entities with a granularity corresponding to a least common ancestor of the one or more hierarchal types (act 1204).

The computing system then receives a modification to the data set changing the identity of the least common ancestor (act 1206). For example, in a data set listing a number of counties spanning two separate U.S. states, the U.S. would be the least common ancestor. If the data set were adjusted by deleting counties so that the remaining counties all reside in the same state, the new least common ancestor would be the state in which the remaining counties reside. In another example, in a data set of California cities, the least common ancestor would be California. If the data set were adjusted by adding the cities of Portland and Seattle, the new least common ancestor would be the U.S.

As shown, the computing system dynamically updates the granularity of the map according to the received modification to the data set (act 1208). This beneficially enables the generated map to automatically adjust to the most efficient display of the corresponding geographic data. For example, by updating the map display to center around the newly identified least common ancestor, all of the relevant data of the data set is captured by the updated map display without the need for a user to manually adjust zoom and pan parameters to give the most efficient display.

According to some embodiments, the computing system also dynamically updates the projection style of the map according to the received modification to the data set. For example, as the map is dynamically updated to display the geographic data based on the new least common ancestor, the projection style of the map may be adjusted to match a projection style that corresponds to the new least common ancestor (e.g., through a preset or user-selected default setting). In one example, as the least common ancestor is changed from a world or continent level to a country level, the map projection style changes from a Mercator projection to an Albers projection.

In one embodiment, a process for dynamically rendering geographic data includes: identifying geographic entity data within a received data set; identifying geographic entity types of the identified geographic entities; sending identified geographic entity data to a geographic data service for geocoding; receiving least common ancestor information from the geographic data service, the least common ancestor representing the geographic entity that is located lowest in the geographic hierarchy of the identified geographic entities while still being a common ancestor to all of the one or more identified geographic entities; receiving region shapes from the geographic data service; and rendering a map displaying the identified geographic entities, the map having a view structured according to the least common ancestor.

Some embodiments include steps for merging multiple data sets into a common data set and generating a map based on the new data set or updating a previously generated map based on the new data set. By way of example, where two or more separate data sets are merged, a computer system can act to resolve duplicate geographic entities in the data. In some embodiments, differently named geographic entities are recognized as referring to the same geographic entity. For example, the terms “United States” and “U.S.A.” are recognized as referring to the same geographic entity, and the duplicates are combined or otherwise resolved despite having different labels.

In some circumstances, a computer system automatically updates a map in response to the merging of multiple data sources into a single data set. For example, a map may be dynamically updated in response to a newly determined least common ancestor that arises as a result of merging the multiple data sources.

Table 1 illustrates an exemplary data set from which a dynamic map chart may be rendered. In this example, the geographic entities are all states within the United States, and the map will therefore be automatically generated to map the most granular level (states) in a country map of the United States (the least common ancestor).

TABLE 1

| State | Profits |
|---|---|
| Washington | $1780k |
| Oregon | $230k |
| California | $1150k |

Table 2 illustrates another exemplary data set from which a dynamic map chart may be rendered. In this example, the granularity of the data is on the city level, with cities from multiple states, and the map will therefore be automatically generated as a bubble map, where cities and corresponding data are shown as bubbles (e.g., sized according to corresponding data value “profits”) located in their respective states in a map of the United States (the least common ancestor).

TABLE 2

| City | State | Profits |
|---|---|---|
| Seattle | Washington | $1000k |
| Bellevue | Washington | $780k |
| Portland | Oregon | $230k |
| San Jose | California | $600k |
| Los Angeles | California | $550k |

In some embodiments having a data set as in Table 2, where the granularity of the data values are not matched to the most granular region-based entity (e.g., entities having region shapes as opposed to point-based geographic entities), a data aggregation process is carried out to produce correct map visualization. In some embodiments where a color-by-value map is generated, duplicates for each region-based entity are summed (e.g., Seattle and Bellevue in this example). In some embodiments where a color-by-category map is generated, duplicates for each region-based-entity are counted and the highest counted category is selected as the category for that geographic region.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system, comprising:
one or more processors; and
one or more computer readable media having stored thereon instructions that are executable by the one or more processors to configure the computer system to perform at least the following:
receive a user-entered data set, the data set including one or more geographic entities;
parse the data set to identify the one or more geographic entities; and
render a map of the one or more geographic entities according to a least common ancestor of the identified geographic entities, the least common ancestor representing a higher level geographic entity that is a common hierarchal ancestor to all of the identified geographic entities and that is located lowest in a geographic hierarchy of geographic entities.

2. The computer system of claim 1, wherein the data set further includes one or more data values corresponding to respective geographic entities, and wherein the instructions are also executable to configure the computer system to parse the data set to distinguish the one or more geographic entities from the one or more data values.

3. The computer system of claim 2, wherein the instructions are also executable to configure the computer system to render the one or more data values on the map as geo labels, each geo label being associated with a region of the map corresponding to the geographic entity to which the data value is associated.

4. The computer system of claim 2, wherein the data set is a table including one or more dimensions related to the one or more geographic entities and one or more dimensions relating to the data values.

5. The computer system of claim 1, wherein the data set is parsed by comparing data of the data set to an identities library, the identities library identifying terms as representing geographic entities.

6. The computer system of claim 1, wherein the instructions are also executable to configure the computer system to render separate regions of the map in different styles corresponding to data values associated with the geographic entities.

7. The computer system of claim 6, wherein the map is rendered as a choropleth display showing relative values associated with the one or more geographic entities according to a gradated style scheme of the geographic entities.

8. The computer system of claim 6, wherein the map is rendered to display the one or more geographic entities according to one or more different style schemes, each different style scheme corresponding to a separate data category of the one or more data values.

9. The computer system of claim 6, wherein the data set includes one or more point-type geographic entities, and wherein the map is rendered as a bubble chart displaying bubbles that are sized according to data values associated with the one or more point-type geographic entities.

10. The computer system of claim 1, wherein the map is dynamically rendered such that modifications to the data set are automatically rendered on the map.

11. The computer system of claim 1, wherein the instructions are also executable to configure the computer system to restrict rendering of the map to geographic regions of a pre-defined hierarchal level in relation to the least common ancestor.

12. A computer system, comprising:
one or more processors; and
one or more computer readable media having stored thereon instructions that are executable by the one or more processors to configure the computer system to perform at least the following:
receive a listing of a plurality of geographic entities;
for each listed geographic entity, traverse a geographic hierarchy to identify one or more ancestor geographic entities containing the listed geographic entity;
based on the identified ancestor geographic entities, identify a least common ancestor of the listed geographic entities, the least common ancestor representing a higher level geographic entity that is a common hierarchal ancestor to all of the identified geographic entities and that is located lowest in a geographic hierarchy of geographic entities; and
generate mapping data enabling display of the listed geographic entities according to the least common ancestor.

13. The computer system of claim 12, wherein the mapping data is generated from a region dictionary of polygon shapes representing the listed geographic entities.

14. The computer system of claim 12, wherein the least common ancestor is identified by:
for each geographic entity in the listing of geographic entities, traversing up a geographic hierarchy to identify a set of geographic entity ancestors to the geographic entity;
determining a lowest hierarchal level at which all geographic entities of the listing converge to a common single geographic entity; and
identifying the common single geographic entity as the least common ancestor.

15. The computer system of claim 12, wherein the instructions are also executable to configure the computer system to generate geographic region shapes corresponding to the listed geographic entities, the geographic region shapes having a projection style that corresponds to a hierarchal level of the identified least common ancestor.

16. The computer system of claim 15, wherein the instructions are also executable to configure the computer system to automatically change the projection style in response to a modification to the listing that changes the least common ancestor.

17. The computer system of claim 12, wherein the instructions are also executable to identify a geographic entity having a discontiguous region and to generate the mapping data to enable display of the geographic entity having a discontiguous region according to a mainland component and one or more discontiguous region components.

18. A computer system, comprising:
one or more processors; and
one or more computer readable media having stored thereon instructions that are executable by the one or more processors to configure the computer system to perform at least the following:
receive a user-entered data set, the data set including geographic entities of one or more hierarchal types;
render a map of the geographic entities, the map having a granularity corresponding to a least common ancestor of the one or more hierarchal types;
receive a modification to the data set, the received modification changing the least common ancestor of the geographic entities of the data set; and
dynamically update the granularity of the map according to the received modification to the data set in order to automatically render the map to correspond to the modified data set.

19. The computer system of claim 18, wherein the data set further includes one or more data values corresponding to respective geographic entities, and wherein the instructions are also executable to configure the computer system to render separate geographic entities of the map in different styles corresponding to the data values associated with the geographic entities

20. The computer system of claim 19, wherein the instructions are also executable to configure the computer system to dynamically update the map in response to a modification to a data value of the data set.
